(19) United States
(12) Patent Application Publication
(10) Pub. No.: US 2024/0186840 A1
(43) Pub. Date: Jun. 6, 2024

(54) RING CYLINDRICAL CASING AND METHOD FOR PRODUCING A RING CYLINDRICAL CASING OF A ROTATING ELECTROMECHANICAL APPARATUS

(71) Applicant: CHE-MOTOR AG, Baden (CH)

(72) Inventor: Walter Haller, Wettswil (CH)

(73) Assignee: CHE-MOTOR AG, Baden (CH)

(21) Appl. No.: 18/282,807

(22) PCT Filed: Mar. 18, 2022
(86) PCT No.: PCT/EP2022/057160

§ 371 Date: Sep. 19, 2023

(30) Foreign Application Priority Data
Mar. 19, 2021 (WO) PCT/EP2021/057125

(51) Int. Cl. H02K 1/02; H02K 3/47; H02K 5/04; H02K 15/14

(52) U.S. Cl. CPC H02K 1/02; H02K 3/47; H02K 5/04; H02K 15/14; H02K 2207/03; H02K 2213/03

(57) ABSTRACT

A ring cylindrical casing and a method for manufacturing the ring cylindrical casing of a rotating electromechanical apparatus and a rotating electromechanical apparatus including the ring cylindrical casing, wherein the ring cylindrical casing has a substantially cylindrical inner surface and/or substantially cylindrical outer surface, wherein the ring cylindrical casing includes a helical lamination stack of a helically wound strip of magnetically permeable material, having multiple turns, wherein the strip includes two main surfaces and two side surfaces, wherein at least one of the main surfaces includes an insulation coating.

### CROSS-REFERENCE TO RELATED APPLICATIONS

This application is a U.S. National Stage Application that claims the benefit of the filing date of International PCT Application No. PCT/EP2022/057160, filed on Mar. 18, 2022, that in turn claims priority to International PCT Application No. PCT/EP2021/057125, filed on Mar. 19, 2021, that are hereby incorporated by reference in their entirety.

### TECHNICAL FIELD

The present disclosure relates to a ring cylindrical casing and a method for producing a ring cylindrical casing of a rotating electromechanical apparatus. Specifically, the present disclosure relates to a ring cylindrical casing and to a rotating electromechanical apparatus with the ring cylindrical casing and a method for producing the ring cylindrical casing of the rotating electromechanical apparatus.

### BACKGROUND

Rotating electromechanical apparatuses, such as electric motors and electric generators, are well known and used in many domestic, industrial and automotive applications and are available in many sizes and types, depending on their intended use. In many electromechanical apparatuses, an alternating current applied to an electrical winding of a stator generates a rotating electromagnetic field, which induces a torque in a rotor. The rotor has, for example, a set of permanent magnets which interact with the rotating electromagnetic field, rotor coils or rotor windings, rotor conductors through which an induced current generates an electromagnetic field, or soft magnetic materials in which non-permanent magnetic poles of the rotor are induced.

Electric motors or generators typically have a stator which has a stator iron and a stator winding, the stator winding being arranged inside slots of the stator iron. The stator winding comprises conductors in many forms, such as Litz wires, which are wound inside the stator in the slots of the stator iron, or single hairpin wire segments, which are inserted into the slots of the stator iron and then electrically joined together, for example by using laser welding.

Ironless motors, however, have no material of high magnetic permeability inside or extending into a region of the windings. Ironless motors, preferably comprise also a stator iron to direct the magnetic flux. This stator iron is of ring cylindrical form, laying radially outside of the windings opposite to the rotor or can be part of the rotor of an asynchronous motor.

The conventional electromechanical apparatus further comprises a bundle of metal laminations or a stack of metal sheets. An electrical insulation between the sheets reduces eddy currents. The bundle of laminations or the stack of sheets is arranged at the stator or forms at least partially the stator. The bundle of laminations is a medium to direct the magnetic flux and act as a structural support for the stator winding. The stator windings may be arranged through holes or grooves of the bundle of laminations or of the stack of sheets. The conventional bundle of laminations or the conventional stack of sheets is produced by punching or stamping or laser cutting the desired shape out of a big sheet of metal. These punched individual laminations are afterwards grouped together to form the metal-sheet lamination stack which is inserted into the electromechanical apparatus. To hold the punched individual laminations together, pins are, for example, inserted into holes of the individual laminations. Producing lamination stacks or bundles of sheets requires therefore first to place the big sheet of metal into a punching machine, to punch the desired shape out of the big sheet of metal, to group the individual sheets into the desired conventional stack of sheets and to insert the pins into the holes of the individual laminations. Afterwards the bundle of laminations or the stack of sheets is inserted into the stator of the electromechanical apparatus. In other words, the production of the lamination stack requires many different manufacturing steps and different machinery including some extremely expensive machines like huge punching, stamping or laser cut machines.

In addition, the bundle of laminations or the stack of sheets is connected, for example mechanically and/or thermally, to an outer or inner housing of the electromechanical apparatus in order to guide or transfer the produced torque from the stator to the ground and to guide the heat produced in the stator winding to the outside.

The international priority patent application from the same applicant having the international application number PCT/EP2021/057125 with the title “rotating electromechanical apparatus and method of manufacture of stator winding” is herewith incorporated by reference in its entirety.

### SUMMARY

it is an object of the present disclosure to provide ring cylindrical casings for or of a rotating electromechanical apparatus, a rotating electromechanical apparatus and a method to produce the ring cylindrical casing for or of the rotating electromechanical apparatus. In particular, it is an object of the present disclosure to provide a ring cylindrical casing and an electromechanical apparatus with the ring cylindrical casing, which do not have at least some of the disadvantages of the prior art.

According to the present disclosure, these objects are addressed by the features of the independent claims. In addition, further advantageous embodiments follow from the dependent claims, claim combinations and the description.

According to the present disclosure, a ring cylindrical casing of a rotating electromechanical apparatus is disclosed, which comprises a substantially cylindrical inner surface and/or a substantially cylindrical outer surface. The substantially cylindrical inner surface forms the radially arranged inner surface and the substantially cylindrical outer surface forms the radially arranged outer surface of the ring cylindrical casing. According to the present disclosure, the ring cylindrical casing further comprises a helical lamination stack. The helical lamination stack is formed out of a helically wound strip of magnetically permeable material. That helically wound strip of magnetically permeable material has multiple turns. In other words, the strip of magnetically permeable material is arranged in a helical shape, whereby the helical lamination stack is formed. The strip comprises two main surfaces and two side surfaces, wherein at least one of the two main surfaces comprises an insulation coating. In other words, the strip has the shape of an extended rectangular cuboid, bevor being formed into the helical shape, having the two main surfaces, the two side surfaces (which are typically smaller than the main surfaces) and two end surfaces, the tips. According to the present disclosure, at least one of the two main surfaces of the extended cuboid comprises the insulation coating. In other words, it is possible that one of the two main surfaces comprises the insulation coating, for example, the upper main surface or the lower main surface, or both of the main surfaces can comprise the insulation coating. In the helical shape, the main surface of a first turn or winding of the helically wound strip faces a main surface of a directly neighboring or next turn or winding of the helical strip. One of the side surface faces radially inwards, i.e. towards a rotation axis of the helically wound strip, and the other side surface faces radially outwards, i.e. away from the rotation axis of the helically wound strip. This way, each winding or turn of the helically wound strip, if at all, is only in contact with the neighboring windings or turns via the respective coated main surface. The insulation coating has therefore the effect to avoid guiding of induced currents from one winding directly to the next winding, which reduces eddy currents produced by a stator winding of the electromechanical apparatus during its operation as desired. Compared to a conventional lamination stack of ring cylindrical sheets, there is still induced current flowing from one winding to the next. But instead of flowing directly in axial direction to the next winding (for example 0.3 mm) the induced current has to flow a full circumference (for example 300 mm) and has therefore no significant influence on the performance of the electromechanical apparatus.

The helically wound strip of the magnetically permeable material follows the shape of a helix to form the helical lamination stack having multiple turns. The ring cylindrical casing, which performs the task of a conventional sheet lamination stack of a conventional electromechanical apparatus, herein comprises the at least one single strip of the magnetically permeable material wound in the helical shape. The helical stack winding advantageously allows to massively reduce waste of magnetic permeable material compared to manufacturing conventional sheet lamination stacks for conventional electromechanical apparatuses or compared to conventional ring cylindrical casings of the electromechanical apparatuses. Furthermore, manufacturing the helical lamination stack according to the present disclosure requires far less manufacturing steps compared to conventional sheet lamination stacks produced as described above.

In an embodiment, the magnetically permeable material of the strip is an iron alloy. The iron alloy is, for example, a silicon iron alloy, preferably a silicon iron alloy comprising a silicon content by weight between 1.5% and 6%, more preferably a silicon iron alloy comprising a silicon content by weight between 2.5% and 3.5%. In another embodiment, the iron alloy is a cobalt iron alloy, preferably a cobalt iron alloy comprising a cobalt content by weight between 1.5% and 6%, more preferably a cobalt iron alloy comprising a cobalt content by weight between 2.5% and 3.5%. These materials provide the required electromagnetic properties for the helical lamination stack to reduce advantageously eddy currents during operation of the electromechanical apparatus.

In an embodiment, the strip of the coated magnetically permeable material has a constant thickness and width. In other words, the helically wound strip of the coated magnetically permeable material has throughout its entire axial extension a constant thickness and width. This creates the advantage that the formed helical lamination stack has throughout its entire axial extension the same dimensions. It is thereby possible to create an advantageous uniform inner and outer cylindrical surface of the helically wound strip. In addition, the neighboring main surfaces do not protrude over each other, which advantageously increases the surface smoothness and thus electromagnetically properties of the helical lamination stack.

In embodiments, the dimensions of the strip of the magnetic permeable material, in particular the thickness and width of the strip, are chosen such that sufficient form-stability of the strip during manufacturing can be achieved and at the same time that sufficient eddy current suppression can be achieved in the helical lamination stack.

In an embodiment, the strip of the magnetically permeable material is between 0.1 mm and 0.5 mm thick, preferably between 0.19 mm and 0.36 mm thick, and/or wherein the strip of coated permeable material is between 2 mm and 10 mm wide, preferably between 3.4 mm and 5.1 mm. For example, the strip has a minimal thickness of 0.1 mm and a minimal width of 2 mm. In another embodiment, the strip has a medium thickness of 0.35 mm and a medium width of 5 mm. Having the thickness and the width of the above-mentioned dimensions produces the desired form-stability of the strip for helically winding it and of the resulting helical lamination stack, which increases the manageability of the strip and helical lamination stack during the manufacturing process. On the other hand, the main task of the helical lamination stack is to reduce eddy currents and to increase thereby the efficiency in operation of the electromechanical apparatus. This is advantageously achieved by providing thin layers of magnetically permeable materials and a thin insulation in between. Thereby, long and narrow (helical) current paths are provided, which reduce the formation and propagation of eddy currents. The helical lamination stack with the strip having the above-mentioned dimensions with a large number of windings or turns per axial extent, i.e. with a high density of windings or turns, of the helically wound strip creates the desired high stacking factor for the advantageous reduction of eddy currents during operation of the electromechanical apparatus. The strip having the above-mentioned thickness and width provides the desired eddy current reduction in the helical lamination stack after manufacturing in combination with the necessary form-stability for an advantageous manageability during and after manufacturing of the helical lamination stack.

In an embodiment, the insulation coating of the strip of the magnetically permeable material is between 1 μm and 10 μm, preferably between 2 μm and 7.5 μm, more preferably between 3 μm and 7 μm. The insulation coating has, for example, a thickness of 3 μm. The thickness of the insulation coating defines the gap between the magnetically permeable material of two windings or turns next to each other in the helical lamination stack, if no further distance is present between two neighboring windings of the helical lamination stack and therefore influences the stacking factor. The insulation coating provides electrical insulation to avoid the flow of induced current from one winding to the next neighboring winding. The thickness of the insulation coating should be large enough to provide the required electrical insulation and at the same time should be small enough to take up as little space as possible. The above-mentioned dimensions of the insulation coating provide an optimal choice between required thickness of the insulation coating and taking up as little space as possible.

In an embodiment, the insulation coating is an insulating varnish. The insulation varnish is for example a backlack—coating or varnish. The insulation varnish on at least one main surface of the strip can after the formation of the helical lamination stack be glued on the full contact surface of the strips by a thermal process to form a solid, stand-alone ring cylindrical casing. In other words, the thermal process forms a permanent connection between one main surface of the strip of one winding with the neighboring main surface of the next winding, creating thereby the solid form of the helical lamination stack. This solid form avoids inadvertent displacements of the helical strip and facilitates the process of inserting or arranging the helical lamination stack into or on a support cylinder of the ring cylindrical casing. Such a solid form of the helical lamination stack may also be achieved via a different coating.

In an embodiment, the insulation coating is an insulation layer which is positioned between two neighboring main surfaces of the helical lamination stack.

In an embodiment, the helical lamination stack comprises a plurality of the strips of magnetically permeable material having the insulation coating as disclosed herein, in particular insulation coating on at least one main surface, each strip being wound helically with multiple turns, wherein the plurality of strips of the magnetically permeable material are arranged parallel and coaxially to each another, thereby forming a multiple-geared helical lamination stack. According to this embodiment, more than one helical wound strip are arranged in the helical lamination stack. This reduces advantageously the manufacturing time of the helical lamination stack. According to this embodiment it is also possible to have different magnetically permeable materials or different insulation coatings in the helical lamination stack, which may further increase the electromagnetically properties of the helical lamination stack. In an embodiment, the different strips of magnetically permeable material may also have different dimensions, in particular, a different thickness, thereby creating advantages lamination properties and electromagnetically properties for the helical lamination stack. According to this embodiment, a main surface of one of the strips is arranged next to a main surface of another one of the strips, in particular of the (next or immediate) neighboring strip.

In an embodiment, neighboring main surfaces of the strip or the plurality of strips are arranged with negligible gaps between each other such that a full-surface hollow cylinder of magnetically permeable material is formed. In other words, the insulation coating surface of one winding touches the main surface of the neighboring winding or the opposite insulation coating of the neighboring winding. Almost no air or other material is between neighboring windings. According to this embodiment, the electromagnetically properties, in particular, the stacking factor, are advantageously increased for the helical lamination stack due to high efficient use of space.

In an embodiment, the helical lamination stack comprises a continuous helically wound strip of magnetically permeable material having multiple turns. In other words, the helical lamination stack is formed out of only one strip of magnetically permeable material having the insulation coating on at least one of the two main surfaces. Thereby, manageability during the manufacturing process is increased.

In an embodiment, the ring cylindrical casing comprises a plurality of the helical lamination stacks, which are arranged coaxially next to each other. In other words, the ring cylindrical casing comprises segments of several, preferably identical, helical lamination stacks arranged at different axial positions, in particular stacked, along the cylinder axis of the ring cylindrical casing. In an embodiment, the plurality of the helical lamination stacks is arranged or stacked with a negligible axial gap next to each other. In another embodiment, the plurality of the helical lamination stacks is arranged with a determined axial gap next to each other. According to these embodiments, it is possible to manufacture several helical lamination stacks simultaneously and to place them afterwards together to be comprised in or to form the ring cylindrical casing. Thereby, the production time can be reduced.

In an embodiment, the ring cylindrical casing further comprises a support cylinder arranged coaxially with the helical lamination stack, wherein a permanent connection is formed between the support cylinder and the helical lamination stack. The support cylinder is configured to hold the helical lamination stack in place and to guide torque, coming from the electromechanical apparatus, to the ground. In an embodiment, the support cylinder is arranged next to the outer radial surface of the helical lamination stack. In another embodiment, the support cylinder is arranged next to the inner radial surface of the helical lamination stack. The support cylinder and the helical lamination stack are connected via the permanent connection, creating thereby the desired mechanical connection to achieve the above mentioned requirements. The permanent connection is, for example, a permanent mechanical and thermal connection, which transfers mechanical forces and heat from the helical lamination stack to the support cylinder. The connection may be formed via a form-fit, a force-fit or a chemical fit connection. The helical lamination stack is, for example, press fitted, screwed, shrinked, cast and/or glued into or on the support cylinder. In this embodiment, the ring cylindrical casing is formed by the support cylinder and the helical lamination stack.

According to a further aspect of the present disclosure, a rotating electromechanical apparatus comprises the ring cylindrical casing according to any one of the embodiments described herein.

In an embodiment, a ring-cylindrical stator, in particular ironless stator, of the rotating electromechanical apparatus comprises the ring cylindrical casing and/or wherein a rotor of the rotating electromechanical apparatus comprises the ring cylindrical casing. In other words, the stator comprises the ring cylindrical casing, or the rotor comprises the ring cylindrical casing.

The ring cylindrical casing functions as a support structure for stator windings of the ring-cylindrical ironless stator. The stator winding is bound to the ring cylindrical casing, for example by a potting material to fix the wires of the winding in the right position, to transfer the torque from the winding to the casing and to transmit the heat from the winding to the outside. The rotor is arranged coaxially with the ironless stator, either inside the stator in the case of an internal rotor, or outside the stator, in the case of an external rotor.

The rotating electromechanical apparatus includes the fixedly arranged stator and the rotatable rotor and is, for example, an electric motor or an electric generator, in particular a ring-shaped electric motor or ring-shaped electric generator, and/or in particular a radial flux electric motor or a radial flux electric generator.

In embodiments, the cylindrical inner and/or outer surface of the ring cylindrical casing is or are substantially cylindrical without significant protrusions. In particular, the inner and/or outer surface of the ring cylindrical casing does not have any slots configured to receive any winding of the stator. As the ring cylindrical casing does not extend into a region of the stator windings, the stator is commonly referred to as an ironless stator, which has no material of high magnetic permeability inside or extending into a region of the windings.

An advantage of having an ironless stator is that the electromechanical apparatus has a higher electric efficiency and requires less space in radial dimension, in particular, can be manufactured in ring-cylindrical shapes of reduced radial dimensions. Further, the electromechanical apparatus with the ironless stator does not have a pronounced cogging effect. However, to date, ironless motors have typically been applied mainly to electric motors of small sizes and power. The ring cylindrical casing according to the present disclosure provides the required electromagnetically properties with the helical lamination stack for the usage of ironless stators also for high power industrial or automotive applications.

In an embodiment, the ring-cylindrical ironless stator includes a continuous hairpin winding having at least two layers or includes a continuous wave winding having at least two layers. The continuous hairpin winding comprises wires which are hairpin-shaped and provide straight wire segments which run in parallel to a cylinder axis of the continuous hairpin winding, the cylinder axis being coaxial with a rotational axis of the rotor. Next to a first straight segment, on one or both ends of the straight segment, the wire is folded and bent such that a subsequent second straight segment runs anti-parallel at a distance to the first straight segment. The hairpin winding is continuous in that each hairpin wire section, defined by comprising one or two or few straight segments, is continuous with the next hairpin wire section. In particular, there is no necessity for electrical joins created by welding, soldering, or similar technique between the hairpin wire sections. However, the wires of the continuous hairpin winding may ultimately be joined by some welding or similar technique at their ends, e.g. for star-grounding or delta-connecting different phases of the continuous hairpin winding. The continuous hairpin winding has two layers of hairpin wire one upon the other when seen in a radial direction. A given wire changes position, for example, from a first layer to a second layer or vice versa when seen around the continuous stator winding such that the first straight segment is arranged in the first layer and then is folded and bent such that the second or subsequent or next straight segment is arranged in the second layer.

In a further aspect of the present disclosure, a method for manufacturing a ring cylindrical casing as disclosed herein is described, having a substantially cylindrical inner surface and/or substantially cylindrical outer surface of a rotating electromechanical apparatus. The method comprises the step of bending a strip of magnetically permeable material, comprising two main surfaces and two side surfaces, wherein one or two of the main surfaces comprise(s) an insulation coating, around an axis of rotation multiple times to form a helical lamination stack. In other words, the strip of magnetically permeable material is formed into the helical lamination stack by bending the strip multiple times, thereby creating multiple windings or turns, around the axis of rotation. In an embodiment, the bending is performed using a plurality of rollers arranged at specific positions to bring the strip into the desired helical shape. The bending of the strip is in particular simple and fast to create the desired helical lamination stack.

In an embodiment, a plurality of strips of magnetically permeable material, arranged next to each other, is bent around the axis of rotation to form the helical lamination stack. According to this embodiment a multiple-geared helical lamination stack is formed, in other words, the helical lamination stack follows the shape of a multiple-geared helix. The main surfaces of the strips are, for example, arranged next to each other before bending around the axis of rotation.

In an embodiment, the method further comprise to form a permanent connection between the helical lamination stack and a support cylinder, which is arranged coaxially with the helical lamination stack, thereby forming the ring cylindrical casing. In this embodiment, the ring cylindrical casing is formed by or comprises the helical lamination stack and the support cylinder. According to this embodiment, the helical lamination stack, or a plurality of helical lamination stacks is arranged at or in the support cylinder and connected to the support cylinder to form the desired permanent connection. The connection is, for example, formed via a form-fit, press-fit, force-fit or a chemical connection. The helical lamination stack is, for example, press fitted, screwed, shrinked and/or glued into or on the support cylinder. In this embodiment, the ring cylindrical casing is formed by the support cylinder and the helical lamination stack.

In an embodiment, the method further comprises the preparatory step of positioning the strip such that the two main surfaces of the strip are arranged perpendicular with respect to the manufacturing axis of rotation. If, for example, the strip is cut from a large roll of coated magnetically permeable material, it may be necessary to place the two main surfaces of the strip perpendicular with respect to the axis of rotation, so that after the bending step, the main surfaces of different windings or turns of the helical lamination stack face other (coated) main surfaces of neighboring windings. In a further embodiment, the strip is bent around the axis of rotation, creating thereby further the desired constant pitch angle of the helically wound strip, which defines the inclination of the helically wound strip. This is, for example achieved via different rollers.

In an embodiment, the method further comprises the preparatory step of cutting the strip of magnetically permeable material from a roll of magnetically permeable material. The insulation coating is, in an embodiment, arranged on the surface of the rolled magnetically permeable material prior to the preparatory step of cutting the strip from the roll.

In an embodiment, the strip of coated magnetically permeable material is helically wound around a cylindrical mounting support, which is arranged coaxially with respect to the axis of rotation to form the helically wound strip. The cylindrical mounting support corresponds, in an embodiment, to the support cylinder. The cylindrical mounting support is, for example, a support for bending the strip with the desired curvature radius and the desired pitch angle to create the helical lamination stack. In other embodiments, the cylindrical mounting support is removed after winding the strip into the helical lamination stack or after fixing the helical laminations stack to the ring cylindrical casing or cylindrical support thereof.

In an embodiment, during bending of the strip, the rotation speed of the cylindrical support is controlled such that the resulting winding speed matches the feed speed of the strip of coated magnetically permeable material.

In an embodiment, a tip of the strip of magnetically permeable material is engaged with the cylindrical support and the strip is bent around the cylindrical support by simultaneously rotating the cylindrical support and axially displacing the strip to be fed to the cylindrical support or by axially displacing the cylindrical support.

### BRIEF DESCRIPTION OF THE DRAWINGS

The present disclosure will be explained in more detail, by way of example, with reference to the drawings in which:

FIG. 1: shows schematically a rotating electromechanical apparatus according to an embodiment of the invention with cut-away sections to show the interior of the apparatus;

FIG. 2: shows schematically a helical lamination stack according to a first exemplary embodiment;

FIG. 3: shows schematically a method for manufacturing of a helical lamination stack according to a first exemplary embodiment;

FIG. 4: shows schematically a cylindrical continuous hairpin winding according to a first exemplary embodiment.

### DETAILED DESCRIPTION

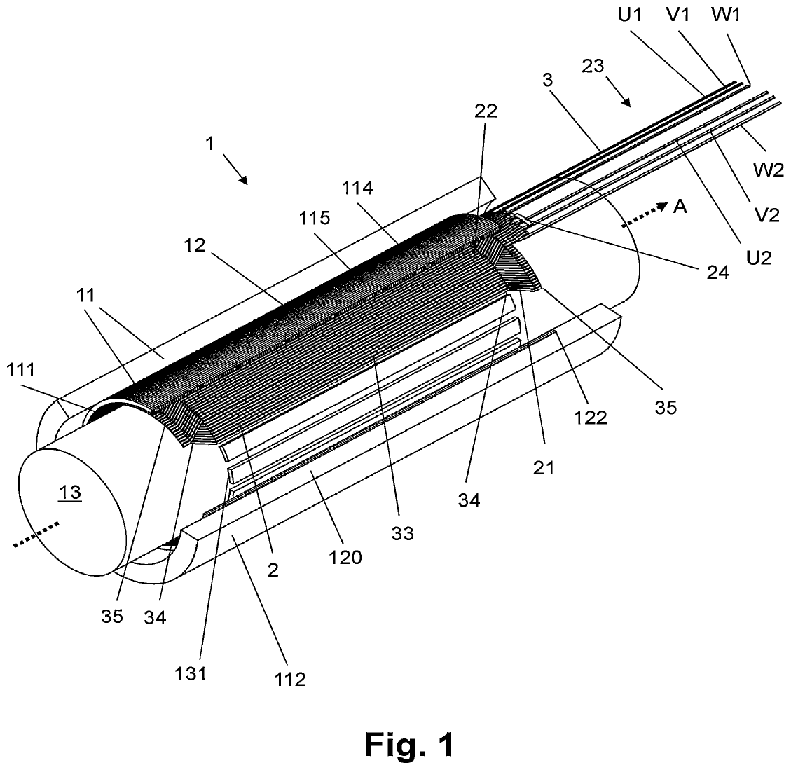

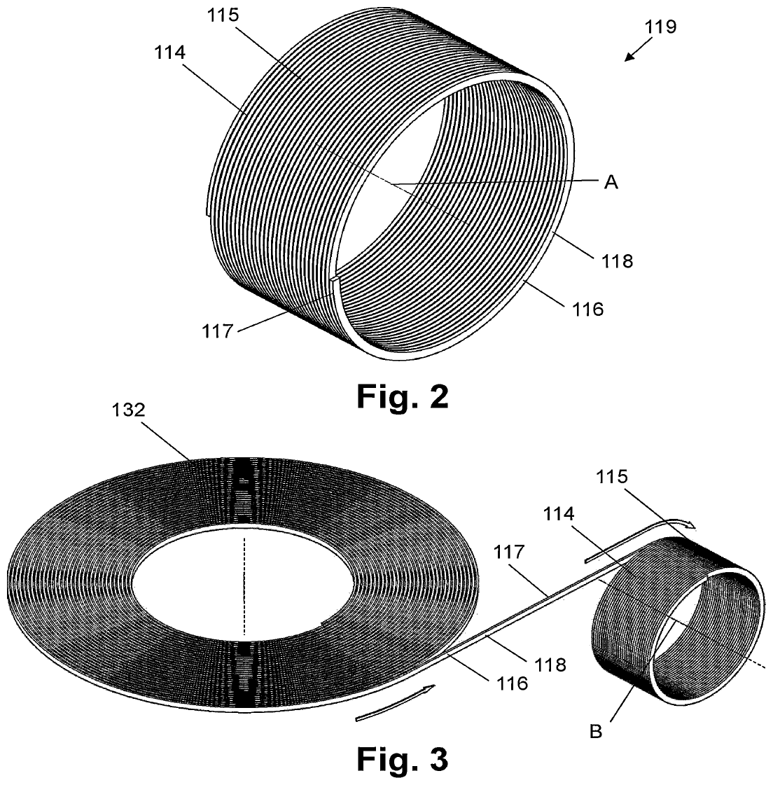

FIG. 1 shows a highly schematic perspective view of an electromechanical apparatus 1 according to an embodiment of the invention with a cut-out to show its interior. The electromechanical apparatus 1 comprises a ring cylindrical casing 11 having an inner surface 111 and an outer surface 112. The ring cylindrical casing 11 comprises a helical lamination stack 114 and a support cylinder 120 both forming the ring cylindrical casing 11 and being part of a stator 12. The helical lamination stack 114 is formed out of a helically wound strip 115 of magnetically permeable material. The helically wound strip 115 comprises two main surfaces 116 and two side surfaces 117 (shown in FIGS. 2 and 3). The outer surface of the support cylinder 120 forms the outer surface 112 of the ring cylindrical casing 11 and the inner surface of the helical lamination stack 114 forms the inner surface 111 of the ring cylindrical casing 11, at least in an axial region facing or surrounding a stator winding 2. FIG. 1 further shows that the support cylinder 120 comprises a radial step, which is in contact with an axial end of the helical lamination stack 114 and forms thereby an axial stop 122 for the helical lamination stack 114 within the support cylinder 120. The strip 115 further comprises an insulation coating 118 (shown in FIGS. 2 and 3) which is arranged on at least one of the main surfaces 116 of the strip 115.

In this embodiment, the helical lamination stack 114 is connected with the support cylinder 120 via a permanent connection. The connection is, for example, formed via a form-fit, press-fit, force-fit or a chemical connection. The helical lamination stack 114 is, for example, press fitted, screwed, shrinked and/or glued into or on the support cylinder 120.

The ring cylindrical casing 11 encloses a cylindrical region. Within the cylindrical region, the continuous hairpin winding 2 is arranged facing against the inner surface 111 of the casing 11 (only a part of the continuous hairpin winding 2 is shown for illustrative purposes). A rotor 13 is arranged coaxial with the continuous hairpin winding 2 about a common axis A. Permanent magnet poles 131 of the rotor 13 interact with an induced electromagnetic field of the continuous hairpin winding 2 to generate torque in the rotor 13. The continuous hairpin winding 2 can have two layers 21, 22, an inner layer 21 and an outer layer 22. The continuous hairpin winding 2 can have two sets of three phase windings U1, V1, W1, U2, V2, W2 wherein a phase winding U1 of the first set and a corresponding phase winding U2 of the second set have the same electrical phase (and e.g. may be joined together, not shown in FIG. 1). The continuous hairpin winding 2 has input leads 23, comprising wires 3, for each of the phase windings U1, V1, W1, U2, V2, W2 in the same region of the rotating electromechanical apparatus 1 such that electrical connection of the continuous hairpin winding 2 is efficient and uncomplicated. In particular, all input leads are within a common, preferably small, azimuthal angular region. An end of each phase winding U1, V1, W1, U2, V2, W2 is electrically joined to at least one other phase winding of the phase windings U1, V1, W1, U2, V2, W2, for example to form a star ground 24 or delta connection. The continuous hairpin winding 2 comprises straight segments 33 extending parallel to the axis A, bend segments 34, including an offset bend, and a folded segment 35. A longitudinal extension of the poles 131 of the rotor 13 does not extend beyond a region of straight segments 33 of the continuous hairpin winding 2.

As can be seen in FIG. 1, the ring cylindrical casing 11 forms part of an ironless stator 12 of the rotating electromechanical apparatus 1. Specifically, the helical lamination stack 114, the support cylinder 120 and the hairpin windings 2 is comprised by the ironless stator 12. The continuous hairpin winding 2 is covered by the helical lamination stack 114 along its entire axial extension (i.e. its extension parallel to the central axis A). The ring cylindrical casing 11 and in particular the inner surface 111 of the ring cylindrical casing 11, formed by the inner surface of the helical lamination stack 114 is arranged adjacent to the continuous hairpin windings 2 and holds the continuous hairpin windings 2 in position. The continuous hairpin windings 2 entirely arranged within the ring cylindrical casing 11 is thereby protected by the ring cylindrical casing 11 from mechanical damage, shocks, and contaminations.

The helical lamination stack 114 comprises, in an embodiment, a plurality of segments 119 (shown in FIG. 2), wherein each segment 119 is formed out of at least one helical wound strip 115. The segments 119 are, for example, arranged axially next to each other with negligible gaps contacting each other and connected to the support cylinder 120, thereby forming the helical lamination stack 114 of the ring cylindrical casing 11.

The ring cylindrical casing 11 of the stator 12 has advantageous small radial extensions and at the same time a high efficiency and is suitable for large industrial or automotive applications.

FIG. 2 shows schematically a helical lamination stack 114 according to a first exemplary embodiment. The helical lamination stack 114 is formed out of the helically wound strip 115 of magnetically permeable material, e.g. an iron alloy. The strip 115 preferably has a rectangular cross-section. Thus, the strip 115 has two main surfaces 116 and two side surfaces 117. The main surfaces 116 are arranged parallel to each other and form the surfaces with the largest extension in terms of area. The side surfaces 117 are also arranged parallel to each other. Further, the side surfaces 117 are arranged perpendicular to the main surfaces 116 and connect the two main surfaces 116 with each other. The main surfaces 116 and the side surfaces 117 define the mantle of the strip 115. The thickness of the strip 115 is the short extension of the side surfaces 117. The width of the strip 115 is the short extension of the main surfaces 116. The other or long extension of the main surfaces 116 and the side surfaces 117 are defined by the length of the strip 115. The strip is closed or concluded by two end surfaces which form the tips of the strip 115. FIG. 2 further shows the insulation coating 118 which is arranged on at least one of the two main surfaces 116. The insulation coating 118 is configured to electrically insulate two neighboring main surfaces 116 of different turns or windings of the helical lamination stack 114. The insulation coating 118 is in another embodiment arranged at both main surfaces 116. In an embodiment, the helical lamination stack 114 forms a segment 119 which is, for example, arranged with other segments in the ring cylindrical casing 11.

In an embodiment, the helical lamination stack 114 is a multiple geared lamination stack 114 (not shown in FIG. 2). The multiple geared lamination stack 114 is formed out of a plurality of helically wound strips 115 having the same inclination angle or pitch angle. The different strips 115 may have different thicknesses, may comprise different materials and/or may have different insulation coatings.

FIG. 3 shows schematically a method for manufacturing of the helical lamination stack 114. FIG. 3 shows bending the strip 115 of magnetically permeable material around an axis of rotation B multiple times to form the helical lamination stack 114. FIG. 3 further shows a feeding spiral 132 onto which the strip 115 can be arranged in a spiral manner. The strip 115 comprises the main surfaces 116 and the side surfaces 117 and the insulation coating 118 on at least one of the main surfaces 116. The strip 115 is unrolled or unwound from the feeding spiral 132 and rolled or bent around the axis of rotation B into the helically wound form to form the helical lamination stack 114. The bending step is in an embodiment performed using different rollers (not shown) which are in contact with the strip 115 and thereby bend the strip 115 into the helical form.

The strip 115 as shown in FIG. 3 arranged on the feeding spiral 132 has already the desired width as planned for the helical lamination stack 114. In another embodiment, the strip 115, prior to the bending step, is cut after unrolling from the feeding spiral 132 to form the desired width of the helical lamination stack 114. In such an embodiment, the width of the feeding spiral 132 does not correspond to the desired width for the strip 115 and the helical lamination stack 114. In another embodiment, a large roll of magnetically permeable material, optionally comprising the insulation coating 118, is cut to create many feeding spirals 132 having the desired width for the strip 115 and the helical lamination stack 114.

FIG. 3 shows that the axis of the feeding spiral 132 is arranged perpendicular to the axis of rotation B of the helical lamination stack 114. Such positioning creates the advantage that the strip does not have to be rotated or bent by 90 degrees prior to the bending step. The rotation would be necessary, if the axis of the feeding spiral 132 would be arranged parallel to the axis B of the helical lamination stack 114. If this is the case, it is required to position the strip 115 in a preparatory step prior to the bending step, such that the two main surfaces 116 of the strip 115 are arranged perpendicular with respect to the axis of rotation B of the helical lamination stack 114.

The strip 115 as shown in FIG. 3 comprises already the insulation coating 118 on one of the main surfaces 116. In another embodiment, the insulation coating 118 is added or arranged in a coating step prior to the bending step. In other words, the strip 115 of the sheet of metal is coated with the desired insulation material. Afterwards, the sheet of metal is cut and rolled onto the feeding spiral 132, and the coated strip 115 is bent around the axis of rotation B to form the helical lamination stack 114.

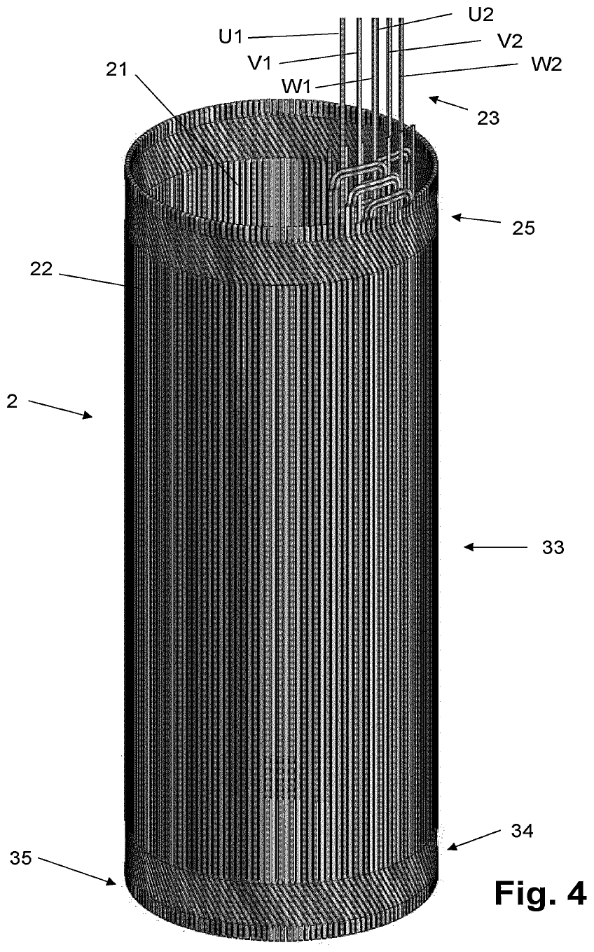

FIG. 4 shows a continuous hairpin winding 2 once it has been rolled into a cylindrical shape. As is shown, all the phase windings U1, V1, W1, U2, V2, W2 have input leads 23 on the same side of the continuous hairpin winding 2 and within the same relatively small azimuthal angular range, which is beneficial for electrically connecting the continuous hairpin winding 2, for example to a power source and/or a motor controller. Further, the opposite ends of the wires 3 from the input leads are also in the same area, allowing for a star-ground or a delta connection between the phase windings U1, V1, W1, U2, V2, W2 to be easily formed. Each phase winding U1, V1, W1 of the first set and each corresponding phase winding of the second set U2, V2, W2 have the same phase. They can be wired together in parallel or in series. FIG. 4 further shows a return bending zone 25.

The continuous hairpin winding 2 is easily and quickly inserted into the cylindrical casing 11 as disclosed herein, in particular without having to deform or bend the continuous hairpin winding 2 in the slightest. This ensures that the continuous hairpin winding 2 maintains its optimal shape with regularly spaced wires 3. Such an optimally shaped continuous hairpin winding 2 is required in particular for the electromechanical apparatus 1 having a very small gap (less than 1 mm) between the continuous hairpin winding 2 and the rotor 13. Having a small gap is obviously advantageous for achieving a higher electromagnetic efficiency and in particular for embodiments where the electromechanical apparatus 1 is ring-cylindrical (with a ring-cylindrical rotor) with a radial thickness that is to be kept as compact as possible.

In an embodiment, the continuous hairpin winding 2 is be potted with a curable potting material. A strong mechanical and thermal bond of the hairpin winding 3 to the ring cylindrical casing 11 is advantageous for the reliable transfer of the torque and to the optimal conduct of the heat. It further provides further structural support and increases the electrical insulation between the wires 3, and improves heat transport away from the wires 3.

In an embodiment, the potting of the continuous hairpin winding 2 and the bonding of the continuous hairpin winding 2 to the ring cylindrical casing 11 takes place in a single step in which the continuous hairpin winding 2 is inserted into the ring cylindrical casing 11 and provided with the curable potting material which further bonds the continuous hairpin winding 2 to the ring cylindrical casing 11.

It should be noted that, in the description, the sequence of the steps has been presented in a specific order, one skilled in the art will understand, however, that the order of at least some of the steps could be altered, without deviating from the scope of the disclosure.

### LIST OF REFERENCE NUMERALS

rotating electromechanical apparatus, electric motor, electric generator 1
ring cylindrical casing 11
inner surface (of casing) 111
outer surface (of casing) 112
helical lamination stack 114
helically wound strip 115
main surface 116
side surface 117
insulation coating 118
segment 119
support cylinder 120
axial stop 122
ring-cylindrical ironless stator 12
rotor 13
rotor magnets 131
feeding spiral 132
continuous hairpin winding 2
first layer (of continuous hairpin winding) 21
second layer (continuous hairpin winding) 22
input leads 23
star ground 24
return bending zone 25
wires 3
straight segment 33
bent segment, offset bend 34
folded segment 35
axis of rotations A, B

1. A rotating electromechanical apparatus, comprising a ring-cylindrical stator, in particular an ironless stator, wherein the ring-cylindrical stator comprises a ring cylindrical casing having a substantially cylindrical inner surface and/or substantially cylindrical outer surface, wherein the ring cylindrical casing comprises a helical lamination stack of a helically wound strip of magnetically permeable material, having multiple turns, wherein the strip comprises two main surfaces and two side surfaces, wherein at least one of the two main surfaces comprise an insulation coating, and wherein the ring-cylindrical stator further comprises a continuous hairpin winding having at least two layers.

2. The rotating electromechanical apparatus according to claim 1, further comprising a rotor, which comprises permanent magnets, or wherein the rotor comprises a continuous hairpin winding having at least two layers or a continuous wave winding having at least two layers.

3. The rotating electromechanical apparatus according to claim 1, wherein the magnetically permeable material of the strip is an iron alloy.

4. The rotating electromechanical apparatus according to claim 1, wherein the strip of magnetically permeable material has a constant thickness and width.

5. The rotating electromechanical apparatus according to claim 4, wherein the strip of magnetically permeable material is between 0.1 mm and 0.5 mm thick, and/or wherein the strip of magnetically permeable material is between 2 mm and 10 mm wide.

6. The rotating electromechanical apparatus according to claim 1, wherein the insulation coating of the strip of the magnetically permeable material is between 1 μm and 10 μm thick.

7. The rotating electromechanical apparatus according to claim 1, wherein the helical lamination stack comprises a plurality of the strips of magnetically permeable material having the insulation coating, each wound helically with multiple turns, wherein the plurality of strips of the magnetically permeable material are arranged coaxially forming a multiple-geared helical lamination stack.

8. The rotating electromechanical apparatus according to claim 1, wherein neighboring main surfaces of the strip or the plurality of strips are arranged with negligible gaps between each other such that a full-surface hollow cylinder of magnetically permeable material is formed.

9. The rotating electromechanical apparatus according to claim 1, wherein the helical lamination stack comprises a continuous helically wound strip of magnetically permeable material having multiple turns.

10. The rotating electromechanical apparatus according to claim 1, wherein the ring cylindrical casing comprises a plurality of the helical lamination stacks which are arranged coaxially next to each other on the ring cylindrical casing.

11. The rotating electromechanical apparatus according to claim 1, wherein the ring cylindrical casing further comprises a support cylinder arranged coaxially with the helical lamination stack, wherein a permanent connection is formed between the support cylinder and the helical lamination stack.

12. The rotating electromechanical apparatus according to claim 1, wherein a rotor of the rotating electromechanical apparatus comprises the ring cylindrical casing comprising the helical lamination stack.

13. The rotating electromechanical apparatus according to claim 1, being an electric motor or generator.

14. A method for manufacturing a ring cylindrical casing of a rotating electromechanical apparatus according to claim 1, the method comprising the step of:
bending a strip of magnetically permeable material around an axis of rotation multiple times to form a helical lamination stack, wherein the strip comprises two main surfaces and two side surfaces, wherein at least one of the two main surfaces comprises an insulation coating.

15. The method according to claim 14, further comprising:
forming a permanent connection between the helical lamination stack and a support cylinder, which is arranged coaxially with the helical lamination stack, thereby forming the ring cylindrical casing.

16. (canceled)

17. The rotating electromechanical apparatus according to claim 5, wherein the strip of magnetically permeable material is between 0.19 mm and 0.36 mm, and/or wherein the strip of magnetically permeable material is between 3.4 mm and 5.1 mm.

18. The rotating electromechanical apparatus according to claim 6, wherein the insulation coating of the strip of the magnetically permeable material is between 2 μm and 7.5 μm.

19. The rotating electromechanical apparatus according to claim 6, wherein the insulation coating of the strip of the magnetically permeable material is between 3 μm and 7 μm.

20. The rotating electromechanical apparatus according to claim 4, wherein the strip of magnetically permeable material is between 0.1 mm and 0.5 mm thick, the strip of magnetically permeable material is between 2 mm and 10 mm wide, and the insulation coating of the strip of the magnetically permeable material is between 1 μm and 10 μm thick.
